(19) United States
(12) Patent Application Publication
(10) Pub. No.: US 2025/0326321 A1
(43) Pub. Date: Oct. 23, 2025

(54) MANAGEMENT OF THE CHARGING OF AN ELECTRIC VEHICLE, CORRESPONDING CHARGING TERMINAL AND CORRESPONDING CHARGING MANAGEMENT SERVER

(71) Applicant: Orange, Issy-Les-Moulineaux (FR)

(72) Inventors: Micheline PERRUFEL, Chatillon Cedex (FR); Garry BRUNEAU, Chatillon Cedex (FR); Philippe QUESSON, Chatillon Cedex (FR)

(21) Appl. No.: 18/869,797

(22) PCT Filed: May 25, 2023
(86) PCT No.: PCT/EP2023/064050

§ 371 Date: Nov. 26, 2024

(30) Foreign Application Priority Data
May 30, 2022 (FR) FR2205165

(51) Int. Cl. B60L 53/66; B60L 53/30; B60L 53/65; B60L 53/68

(52) U.S. Cl. CPC B60L 53/665; B60L 53/305; B60L 53/65; B60L 53/68; B60L 2240/72

(57) ABSTRACT

The management of the charging of an electric vehicle, via a charging terminal. A method for managing this charging includes: connecting a charging cable between the electric vehicle and the charging terminal; the charging terminal receiving authentication data in relation to the electric vehicle; the charging terminal triggering the charging at the end of an inspection on the authentication data when the authentication data concern a second user, different from the first user and authorized to carry out charging.

### CROSS-REFERENCE TO RELATED APPLICATIONS

This application is filed under 35 U.S.C. § 371 as the U.S. National Phase of Application No. PCT/EP2023/064050 entitled “MANAGEMENT OF THE CHARGING OF AN ELECTRIC VEHICLE, CORRESPONDING CHARGING TERMINAL AND CORRESPONDING CHARGING MANAGEMENT SERVER” and filed May 25, 2023, and which claims priority to FR 2205165 filed May 30, 2022, each of which is incorporated by reference herein in its entirety.

### BACKGROUND

### Field

The field of the development is that of managing the charging of electric vehicles. More specifically, the development relates to monitoring the electrical consumption generated by such a charging, particularly, but not exclusively, in the case of a professional electric vehicle charged by its user at their home.

### Description of the Related Technology

As part of COP21 (21st Conference of the Parties to the United Nations Framework Convention on Climate Change), an international climate agreement, applicable to the 196 signatory countries, was validated on 12 Dec. 2015. This international agreement aims to limit global warming to 1.5 to 2 degrees Celsius by 2100.

Following on from this agreement, in France, the Tertiary sector decree was promulgated in 2019: it constitutes a regulatory obligation committing players in the tertiary sector to energy sobriety, and requiring them to reduce their energy consumption progressively by 40% in 2030, 50% in 2040 and 60% in 2050, in relative terms over a reference year.

While most forecasters believe that our energy consumption will fall by 2050 thanks to greater energy efficiency, they do predict an increase in the share of electricity in the energy mix. Indeed, if we are to move away from fossil fuels such as gas, coal and oil, we will need to electrify our uses (transport, heating, industry). In France, the operator of the Réseau de Transport d'Électricité (RTE) estimates that electricity requirements will increase by 35% by 2050. At the same time, electricity production costs are expected to rise by around 15%.

A priori, this trend in electricity consumption does not seem to be driven by the trend in heating costs alone, and the growing popularity of electric and plug-in hybrid vehicles is playing an important part. Indeed, France is the second European country where the most 100% electric vehicles are purchased. Thus, In France, 194,730 electric and plug-in hybrid vehicles were sold in 2020, that is 125,264 more than in 2019, i.e. an increase of 180%, 111,000 of these vehicles are electric vehicles (that is an increase of 159%), and 83,000 are plug-in hybrids (that is an increase of 304%).

More and more companies are thus opting to migrate their fleet of professional combustion engine vehicles to an all-electric and/or plug-in hybrid fleet. The employees of these companies regularly have to charge their professional vehicles. For this purpose, they can use:
public electric charging terminals, which use is less and less free of charge;
company electric charging terminals on their workplace;
home electric charging terminals, currently estimated to cost around €17 c/kWh.

In the case where employees opt to charge their vehicle at home, the question arises as to whether the company should reimburse the employee for the actual cost for charging this electric or hybrid vehicle for occupational use.

To date, charging cost simulators enable companies and their employees to estimate the cost for charging the electric vehicle. However, these simulators can only estimate the electricity consumption generated by charging the battery.

Furthermore, charging an electric car at home requires the user to make more or less costly arrangements. In fact, it is difficult to plug one's electric vehicle into a household socket, which in France is limited to 10 A. A heavy-duty socket and/or a Wallbox® charging terminal must therefore be installed.

The heavy-duty socket must be installed by a professional, in conjunction with a suitable circuit breaker. With a heavy-duty socket, the charging of electric vehicles is slow.

Wallbox® charging terminals are devices dedicated to charging electric vehicles. There are as many Wallbox® models as there are suppliers (Legrand®, Schneider®, or specialist manufacturers such as EVBox® that collaborates with Engie®, or even car manufacturers today) and each has its own technology and a wide range of options. Although more expensive to install than a heavy-duty socket, the Wallbox® charging terminal has the advantage of allowing accelerated charging. It may require the user to increase the power of their electricity meter. Furthermore, these charging terminals offer a number of additional features compared with heavy-duty sockets, such as a warning light when the electric vehicle is charged, or Wi-Fi® or Bluetooth® connected technology, for controlling the charging of the vehicle from an application on the user's smartphone.

However, for the user, the cost for charging their vehicle from this type of terminal is high, as an 11 KW terminal consumes as much energy as eleven small electric radiators.

To date, it is not clear how companies can reimburse these costs to their employees, as there is no solution enabling an employer, on the one hand, to identify precisely the share of household electricity consumption associated with charging a professional electric vehicle and, on the other hand, in the case of charging from a home charging terminal, to ensure that the vehicle concerned is indeed the professional vehicle and not a private vehicle of the user.

If they want to be reimbursed for their expenses by their employer, employees with a professional electric vehicle therefore have no option but to charge at their workplace or at a public charging terminal, where they can prove the amount paid by credit card to charge their professional vehicle.

There is therefore a need for a technique for managing the charging of an electric or hybrid vehicle which does not have all the disadvantages of the prior art. In particular, there is a need for such a technique to monitor the electricity consumption resulting from charging a professional electric vehicle at a home charging terminal. There is also a need for such a technique to ensure that an electric vehicle charged at a home charging terminal is a professional vehicle.

### SUMMARY

The development responds to this need by proposing a method for managing the charging of an electric vehicle, via a home charging terminal of the vehicle of a first user, which comprises the steps of:
connecting a charging cable between the electric vehicle and the home charging terminal;
home charging terminal receiving authentication data of the electric vehicle;
home charging terminal triggering charging after controlling authentication data when the authentication data
relate to a second user, different from the first user and authorised to carry out
charging.

Thus, the development is based on a completely new and inventive approach to managing the charging of electric vehicles in a home environment. Indeed, the development proposes to condition the triggering of the charging of an electric vehicle in a home environment to the home charging terminal controlling authentication data associated with this vehicle. According to the development, charging is authorised when the result of the authentication check indicates that the vehicle belongs to a second user different from the first one and that the first user is authorised by the second user to charge the vehicle. Thus, after the user has connected the charging cable linking the home charging terminal to their vehicle, charging only begins if the charging terminal has been able to check the authentication data of the vehicle. This means, for example, that charging can only be triggered if the charging terminal can check that the vehicle is a vehicle authorised to charge at this terminal (for example, an electric vehicle of a company fleet). This can also make it possible, for example, to identify the vehicle connected to the terminal, so that it can be associated with the electricity consumption associated with the charging that is starting.

According to a first embodiment, the authentication data of the vehicle is an authentication code associated with the vehicle entered by the first user on an input interface associated with the home charging terminal. Such an input interface can be, for example, a digital code panel, associated with the home charging terminal: entering the authentication code on this digital code panel conditions the triggering of the charging of the electric vehicle by the home terminal. Such a digital code panel can be supplied to the user, along with the Wallbox® home terminal, by the company that employs them and provides them with a professional electric vehicle. As a variant, the input interface can be a touch interface, on a screen associated with the charging terminal, or an audio interface associated with the terminal, to which the user sends the authentication code as a voice command. Only the authorised user of the electric vehicle has the authentication code to trigger the charging, which secures the charging process via the home charging terminal. The fact that the authentication code is associated with the vehicle means that it can be identified specifically.

According to a first characteristic, during connection of the charging cable, the home charging terminal sends an authentication data request to a charging management server, capable of generating and transmitting the authentication code to a mobile communication terminal of the first user. According to one aspect, the home charging terminal is connected to a gateway for access to a local communication network, capable of relaying the authentication data request it receives from the home charging terminal to the charging management server via a wide area communication network.

Such a charging management server is preferably a server of the company to which belongs the electric vehicle to be charged. Upon reception of an authentication data request sent by the home charging terminal, and relayed to it by the access gateway of the local communication network to which the home charging terminal is connected, this charging management server generates an authentication code, which it sends to the user's mobile terminal, for example a smartphone. As will be seen in more detail later, the request received from the charging terminal may contain an identifier of the latter, for example in the form of a serial number. This identifier enables the charging management server to identify the user to whom an authentication code is to be sent, by consulting a company database storing in association the identifiers of the Wallboxes® installed in the home of employees, and the contact details of the latter (telephone number, for example). The charging management server can then generate a charging authorisation, comprising an authentication code transmitted to the employee's mobile terminal, to which the identifier of the home charging terminal, and for example an item of timestamp data, are associated.

According to another characteristic, the home charging terminal is connected to the access gateway according to a communication technology belonging to the group comprising:
a Wi-Fi® technology;
a technology that complies with a G.hn standard as specified by the International Telecommunication Union in recommendations G.9960 et seq.

Thus, the home charging terminal can be connected to the gateway for access to a home local communications network via Wi-Fi®. As a variant, G.hn plugs are used to enable the Wallbox® to communicate with the access gateway via the electricity network. This last solution is particularly advantageous when the home charging terminal is installed in the basement of the user's home, or in the basement car park of a building, where the Wi-Fi® radio coverage quality may be insufficient.

According to a second embodiment, the authentication data is transmitted to the home charging terminal by the electric vehicle via the charging cable and comprises a unique identification key of the electric vehicle.

In this second embodiment, the home charging terminal and the electric vehicle therefore exchange a single key when connecting the cable between the car and the home charging terminal. This exchange can be made via the charging cable itself. The electrical socket of the vehicle then incorporates a communication module dedicated to this exchange of information with the home charging terminal. An appropriate software programme can be integrated into the electrical socket of the professional vehicle. The communication protocol used, which is not part of the present development, and which can be any communication protocol suitable for this type of exchange, for example a V2I (Vehicle to Infrastructure) communication protocol, or an extension of the CAN bus, or even power-line communication, will not be described in more detail here.

According to one aspect, the authentication data also comprises a profile of the electric vehicle comprising at least some information relating to the electric vehicle belonging to the group comprising:
an identifier of the electric vehicle;
a mileage of the electric vehicle;
an item of information about the state of the electric vehicle;
an identifier of the first user of the electric vehicle;
an anomaly detected on the electric vehicle.

It is thus possible to enrich the contextual information associated with the charging of the vehicle, for subsequent storage by the company's charging management server. Furthermore, this profile also allows for example the home charging terminal to determine whether the vehicle that connected is a professional vehicle or the user's private vehicle.

In addition, it can also be considered that the home charging terminal sends a confirmation to the electric vehicle user on their mobile terminal that the charging is going to be charged to their private account, or to their company's account, depending on the vehicle profile it has collected.

According to another aspect, the home charging terminal implements an authentication of the electric vehicle based on the unique identification key. Such an authentication means that the charging can be reserved for authenticated vehicles, which are therefore authorised to use this home charging terminal, for example for vehicles belonging to a company fleet.

According to yet another aspect, the charging terminal transmits to a charging management server information relating to the electricity consumption associated with the charging of the vehicle, in association with at least some of the information of the electric vehicle profile. For example, the Wallbox® sends the amount of energy used to charge the vehicle to the company's charging management server, if it has been determined that the vehicle is indeed the user's professional vehicle. The charging management server can then store this item of information, in association with the information of the electric vehicle profile. The cost associated with this energy consumption can then be charged to the company, either directly or via an employee reimbursement procedure.

The development also relates to a computer program product comprising program code instructions for implementing a method for managing the charging of an electric vehicle as described previously, when it is executed by a processor.

The development also relates to a computer-readable storage medium on which is saved a computer program comprising program code instructions for implementing the steps of the method for managing the charging of an electric vehicle according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the above-mentioned display control method.

The development also relates to a home terminal for charging an electric vehicle, comprising a socket for connecting to the terminal a cable for charging the electric vehicle, which comprises:
a module for receiving authentication data of the electric vehicle;
a module for controlling the authentication data configured to activate the triggering of the charging by the charging terminal.

More generally, such a charging terminal comprises a set of modules, memories and processors for implementing the method for charging an electric vehicle described above. Such a terminal can notably comprise an interface for entering an authentication code, or be associated with such an interface, such as a digital code panel, for example. Such a terminal is preferably connected by means of a wired or wireless link to a gateway for access to a local communication network, via which it can establish contact with a charging management server present on a wide area communication network to which this gateway is connected.

The development also relates to a method for controlling the charging of an electric vehicle implemented by a charging management server, which comprises steps of:
receiving a vehicle authentication data request from a home charging terminal to which the electric vehicle is connected, said home charging terminal being arranged in a home of a first user and being configured to implement the charging management method described above;
checking whether said vehicle belongs to a second user different from the first user and whether the first user is authorised to charge the vehicle;
generating and transmitting an authentication code to a mobile communication terminal of said first user.

It will be seen in the following that the first user is authorised by the second user to charge the vehicle.

Thus, the development is based on a new and inventive approach to controlling, in a company for example, the charging of electric vehicles of a fleet of vehicles, for example a fleet of professional vehicles. Indeed, the development proposes to authenticate a vehicle to be charged before authorising such a charging; for this purpose, a charging management server, belonging for example to a company's communications network or connected to the latter, generates an authentication code upon reception of an authentication request from a charging terminal, for example a home terminal. Such a request comprises, for example, an identifier of the charging terminal, enabling the server to identify the user associated with it, by consulting a dedicated database. After verifying the identity of this user, for example an employee with an electric company vehicle, the charging management server sends the generated authentication code to a mobile terminal of the user, whose contact details are stored in the database. This code will then allow the user to trigger the charging of their electric vehicle at the charging terminal.

According to one aspect, the charging management server stores an event log in which it records in association the authentication code, an identifier of the charging terminal contained in the authentication data request and an item of timestamp data associated with the request and/or the authentication code. Such an item of timestamp data can be associated with the time of reception of the authentication data request, or with the time of generation or transmission of the authentication code by the server. It allows to date the charging time of the electric vehicle, and therefore to identify, in the user's electricity consumption statement, the share that corresponds to the charging of their professional electric vehicle.

Thus, according to another aspect, the charging management server sends to an electricity meter present on a local communication network to which the charging terminal is connected, a request to obtain an electricity consumption associated with the charging, the obtaining request containing said item of timestamp data.

The development also relates to a computer program product comprising program code instructions for implementing a method for controlling the charging of an electric vehicle as described previously, when it is executed by a processor.

The development also relates to a computer-readable storage medium on which is saved a computer program comprising program code instructions for implementing the steps of the method for managing the charging of an electric vehicle according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the above-mentioned display control method.

Finally, the development relates to a charging management server of an electric vehicle, which comprises a module for receiving an authentication data request from a charging terminal to which the electric vehicle is connected, and a module for generating and transmitting an authentication code to a mobile communication terminal of the first user of the vehicle.

The development also relates to a, a, and a having a combination of all or some of the features set out throughout this document.

The above-mentioned corresponding charging terminal, charging management server and computer programs have at least the same advantages as those provided by the methods for managing the charging and for controlling the charging of an electric vehicle according to the present development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows the context of the charging of an electric or hybrid vehicle via a private electric charging terminal;

FIG. 2 illustrates in schematic form the technique for managing the charging of an electric vehicle according to a first embodiment of the development;

FIG. 3 illustrates in schematic form the technique for managing the charging of an electric vehicle in a variant of the embodiment of [FIG. 2];

FIG. 4 shows in schematic form the technique for managing the charging of an electric vehicle according to a second embodiment of the development;

FIG. 5 shows in schematic form the hardware structure of a terminal for charging an electric vehicle according to the various embodiments of the development;

FIG. 6 shows in schematic form the hardware structure of a charging management server of electric vehicles according to the various embodiments of the development.

### DETAILED DESCRIPTION OF CERTAIN ILLUSTRATIVE EMBODIMENTS

The general principle of the development is based on authenticating an electric vehicle, prior to its charging at a private charging terminal, for example in a home environment, for the purposes of monitoring the electricity consumption caused by such a charging by a third-party entity, for example by a company that owns the vehicle and employs its user.

In relation to the figures, two main embodiments of the development are now presented, in the context, given merely as an example, of charging a professional electric vehicle connected to a home charging terminal in the user's home. The general principle of this technique can easily be extended to the charging of any other type of electric or hybrid vehicle and to any other charging terminal.

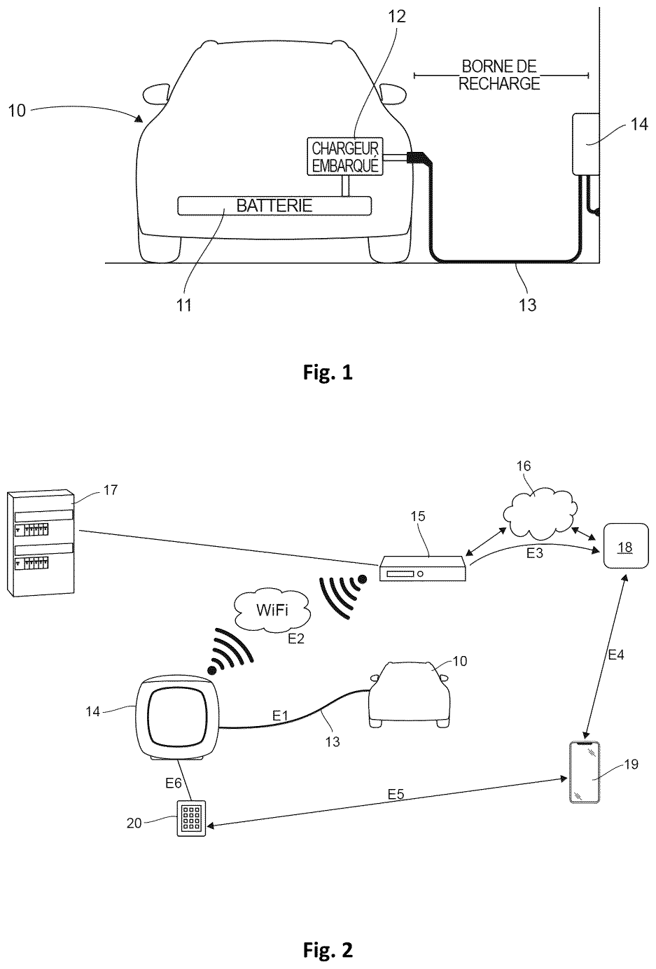

This context is illustrated in summary form in FIG. 1, in which an electric or hybrid vehicle 10 is equipped with a battery 11 and an on-board charger 12. When charging the battery 11, the user of the vehicle 10 connects a charging cable 13 between the on-board charger 12 and a charging terminal 14. Such a charging terminal 14 is, for example, a Wallbox® device, which may have been supplied to the user by their employer, when the professional electric vehicle was made available, or by the vehicle manufacturer, when the vehicle was purchased. Such a charging terminal 14 is installed, for example, in the garage or the basement of the user's home. It is connected to the home electricity network, and preferably also to a wired or wireless home local communication network.

In relation to FIG. 2, a first embodiment is presented, in which the charging terminal 14 is equipped with an input interface enabling a user to enter an authentication code whose controlling by the charging terminal 14 triggers the charging of the vehicle 10. In the example of FIG. 2, the charging terminal 14 is associated with a digital code panel, these two items of equipment being supplied, for example, by the company employing the user. An authentication code is therefore required to use the charging terminal. Thus, the company can ensure that terminal 14 is only used for charging electric vehicles that belong to its fleet of professional vehicles, and not for charging the private vehicle of the user or another member of their family.

FIG. 2 illustrates in schematic form the various steps implemented when charging the user's professional electric vehicle 10 via the home charging terminal 14. During a step E1, the user connects the charging cable 13 between their vehicle 10 and the charging terminal 14. Upon detection of this connection, the charging terminal transmits, during a step E2, a request for authentication data of the vehicle 10, whose verification will condition the effective triggering of the charging of the vehicle 10. In this example, the charging terminal 14 is connected by means of a Wi-Fi® wireless link to a local communication network (LAN), and in particular to an access gateway 15, for example an Orange® Livebox®. This access gateway 15 also forms an access point to a wide area communication network 16, for example the Internet network. The user's electricity meter 17, for example a Linky® smart meter, is also connected to the local communication network and to the access gateway 15 by means of a wireless or wired link.

The authentication data request sent by the terminal 14 comprises an identifier of the latter, for example its serial number. The request is received by the access gateway 15 and routed (step E3), via the wide area communication network 16, to a charging management server 18 of electric vehicles administered by the company that owns the vehicle 10.

Upon reception of the request, the charging management server 18 identifies the charging terminal 14 that issued it, by means of the identifier it contains, and, by consulting a company database, the employee user in whose home this charging terminal 14 has been installed. If the request has indeed been sent by a charging terminal listed in this base, and the corresponding user is part of the personnel authorised to charge a professional electric vehicle at home, the charging management server 18 generates an authentication code, for example a digital code, which it transmits during a step E4 to a mobile terminal 19 of the user of the vehicle 10. This transmission can be done, for example, by sending an SMS (Short Message Service) over a 4G or 5G radiocommunication network. The user's mobile terminal 19 is, for example, a smartphone or a tablet, and can also be a professional device supplied by the company.

Upon reception of this authentication code on their mobile terminal 19, the user enters it during a step E5 on the digital code panel 20 associated with the terminal 14, or integrated into the latter. As a variant, this code can be entered on a touch screen of the terminal 14, or transmitted to the latter as a voice command.

During a step E6, the charging terminal 14 controls the authentication code entered by the user, by comparing it with a version of this code it has received from the access gateway.

At the end of this control, the charging terminal 14 releases the charging action for the vehicle 10, which can therefore begin.

It should be noted that during step E4 of generation and transmission of the authentication by the charging management server 18, the latter also stores, in an event log, all the contextual information associated with this charging of the vehicle 10. This contextual information can comprise the authentication data request received from the charging terminal 14, the identifier of the latter it contains, an associated item of timestamp data, an identifier of the user associated with this charging terminal 14, an identifier of the vehicle 10, the authentication code generated, etc.

In addition, the charging management server 18 can store other information relating to the vehicle 10, such as its mileage, its last charging date, its overall condition, any anomaly detected, etc. This information, such as the mileage and/or the last charging date, can be used to carry out an additional check that it is indeed the professional vehicle that the user is charging, and not their private vehicle or that of their spouse.

At the end of the charging, the charging terminal 14 can send an end-of-charging notification to the server 18, via the access gateway 15. Upon reception of this notification, the server 18 can send a request to the smart meter 17, via the access gateway 15, to obtain the electricity consumption caused by the charging of the vehicle 10. This request comprises, for example, the item of timestamp data generated upon reception of the authentication data request by the server 18, as well as an item of timestamp data generated upon reception of the end-of-charging notification by the server 18, both of which being stored in association in the event log kept by the server 18. This timestamp data enables the smart meter 17 to identify a start time and an end time for the charging of the vehicle 10, and therefore to transmit to the server 18, via the access gateway 15 and the wide area communication network 16, the electricity consumption caused by the charging.

Based on this consumption information, the charging management server 18 can determine an expense reimbursement to be made to the employee user.

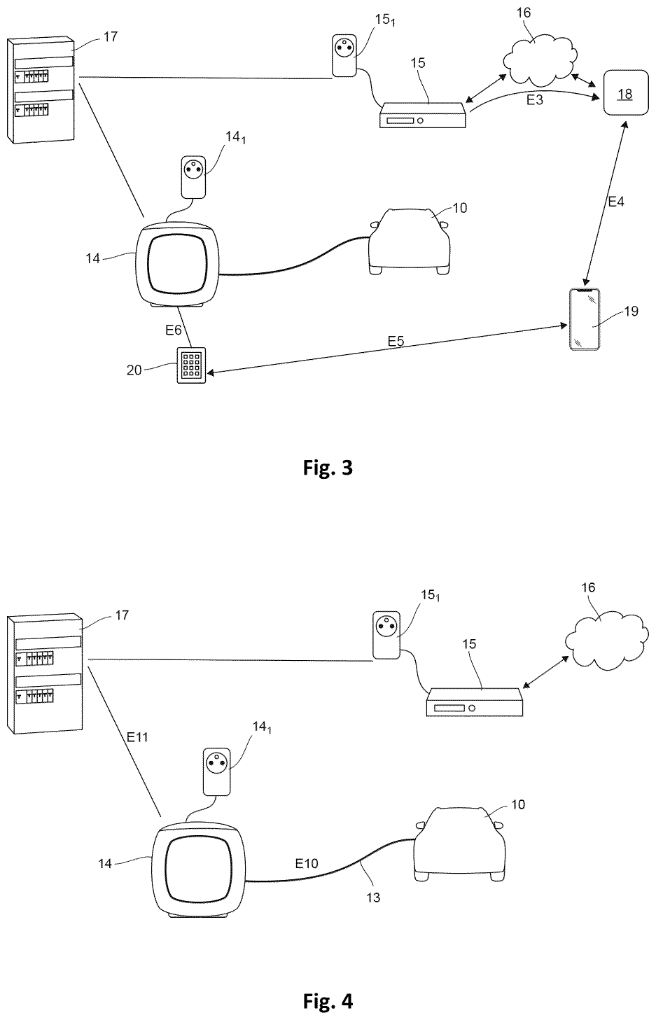

FIG. 3 illustrates an embodiment variant of the principle of FIG. 2, in which the various devices present on the local communication network are equipped with G.hn plugs, and therefore communicate with each other, no longer via Wi-Fi®, but via a wired G.hn technology, as specified by the International Telecommunication Union in recommendations G.9960 et seq. Communication between the local network devices, and in particular the charging terminal 14 and the access gateway 15, therefore takes place via the home's electricity network, or its telephone wiring, or coaxial cables, or optical fibre. The same devices and the same steps are identified in FIG. 3 by the same numerical references as in FIG. 2, and will therefore not be described in greater detail here. In FIG. 3, the presence of a G.hn 14; plug, associated with the charging terminal 14, and a G.hn 15; plug, associated with the access gateway 15, will be noted.

This embodiment variant based on G.hn technology is particularly advantageous in the context of a home environment in which Wi-Fi coverage may be insufficient, particularly in a context where the charging terminals 14 are often installed in a basement or a garage, and out of range of the access gateway 15 of the local communication network.

In relation to FIG. 4, a second embodiment is now presented, in which the procedure for authenticating the vehicle 10 is no longer based on entering an authentication code received from a remote charging management server, but on an exchange of a unique key between the charging terminal 14 and the vehicle 10 when the charging cable connecting them to each other is connected.

During a step E10, the user connects the charging cable 13 between the electric vehicle 10 and the charging terminal 14. The connection socket of the vehicle 10 is equipped with a communication module enabling it to exchange messages, via the charging cable 13, with the charging terminal 14, using any suitable type of communication protocol (for example, the File Transfer Protocol Secure (FTPS) protocol). These exchanges are based notably on a communication protocol involving exchanges of asymmetric cryptographic keys comprising a public key and a private key, thanks to which the charging terminal 14 can authenticate the electric vehicle 10, using a known technique which will not therefore be described in greater detail here.

At the end of this authentication phase, the charging terminal 14 collects the profile of the vehicle 10 (private or professional vehicle), and in particular an identifier for the latter, as well as various associated items of information such as a mileage, an overall state of the vehicle, any anomalies detected, etc.

After collecting this profile, the charging terminal 14 initiates the charging of the vehicle 10 during a step referenced Eli. During this step, it communicates with the smart electricity meter 17 at the user's home, so as to associate the electricity consumption generated by the charging with the profile of the vehicle 10 it has collected.

This communication, within the local communication network, with any other device, such as the electricity meter 17 or the access gateway 15, can be carried out using any appropriate communication technology, and in particular Wi-Fi® or power-line communication technology (PLC and its evolutions). In the example of FIG. 4, a communication using the ITU G.hn technology is represented by way of example: the charging terminal 14 and the access gateway 15 are thus respectively equipped with G.hn plugs, referenced 14; and 15j.

The charging terminal 14 also communicates, via the gateway 15 for access to the home local network, with the Internet network 16, which hosts one or more charging management servers 18 of electric vehicles, not shown.

When the profile of the vehicle 10 indicates to the charging terminal that it is a professional vehicle, the terminal 14 transmits, via the access gateway 15, to a company charging management server 18, identified from the profile of the vehicle 10, an item of information relating to the quantity of energy used for charging the vehicle 10 during step E11. The charging management server 18 stores the item of information and charges the associated costs to the company, either directly or via a reimbursement procedure for the employee user.

As a variant, an additional step of confirming on the user's mobile terminal that the vehicle 10 is going to be charged on their account or on that of their company can be considered.

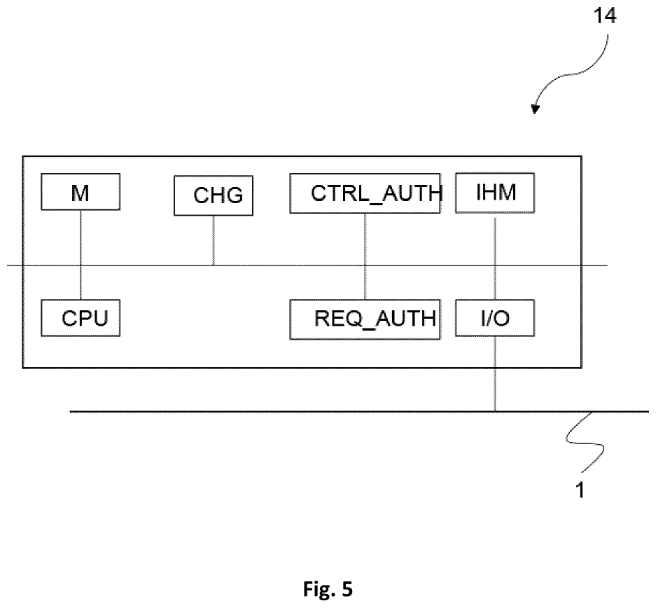

In relation to FIG. 5, the hardware structure of a home charging terminal 14 for an electric vehicle according to one embodiment of the development is now presented. Such a terminal is, for example, a Wallbox® device, supplied by the employer of the electric vehicle's user or by the latter's vehicle manufacturer, and installed in the user's home, for example in their garage, the car park of their building, or the basement of their house.

Such a charging terminal 14 is configured to request, receive and control authentication data associated with the electric vehicle that connects to it, for the purpose of monitoring the electricity consumption associated with the charging of this vehicle, with a view to have the associated billing covered by the company that owns this vehicle

Such a charging terminal 14 therefore comprises:
A REQ_AUTH module for generating a request for authentication data of the vehicle;
A CTRL_AUTH module for controlling this authentication data, which controls the module CHG for the electric charging of the vehicle.

The term “module” can correspond to a software component as well as to a hardware component or a set of hardware and software components, a software component itself corresponding to one or more computer programs or sub-programs, or more generally, to any element of a program capable of implementing a function or set of functions.

The charging terminal 14 typically comprises memories M associated with a processor CPU. The memories can be of type ROM (Read Only Memory), RAM (Random Access Memory) or Flash. It also comprises an input/output module LO that can be connected by means of a wired or wireless link 1 to other devices of the home local communication network, such as an access gateway 15 or a smart electricity meter 17. For example, the link 1 is a G.hn wired link, or a wireless Wi-Li® link. In the first embodiment described in relation to FIGS. 2 and 3, the I/O module is the transmission/reception module that manages the transmission of the authentication data request generated by the REQ_AUTH module to the access gateway 15 of the local communication network, and the reception of the authentication data in return, which can be entered by the user on a dedicated HMI of the terminal 14. In the second embodiment described in relation to [FIG. 4], the I/O module is the input/output module that manages the exchanges between the electric vehicle 10 and the terminal 14, via the charging cable 13, and in particular the exchange of authentication asymmetric keys. The LO module also manages the exchanges between the terminal 14 and the electricity meter 13 for monitoring the energy consumption associated with the charging of the vehicle 10.

The charging terminal 14 also comprises an interface module, noted IHM. This module can be a touch screen integrated into the terminal 14, or a digital code panel 20 integrated into or connected to the terminal, or even a voice control module. This interface module IHM may be optional in the second embodiment of [FIG. 4].

In this second embodiment, the CTRL_AUTH module controls the authentication of the vehicle 10 by the exchange of asymmetric keys, and the collection of the vehicle profile, that can be stored in the memory M, before sending all or part of it to the charging management server 18.

FIG. 5 only shows a particular one of several possible ways of realising the charging terminal 14, so that it executes the steps of the method detailed above, in relation to FIGS. 1 to 4 (in any one of the various embodiments, or in a combination of these embodiments). Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the charging terminal 14 is realised with a reprogrammable computing machine, the corresponding program (i.e. the sequence of instructions) may be stored (or not) in a removable storage medium (such as, for example, a floppy disk, CD-ROM or DVD-ROM), this storage medium being partially or totally readable by a computer or a processor.

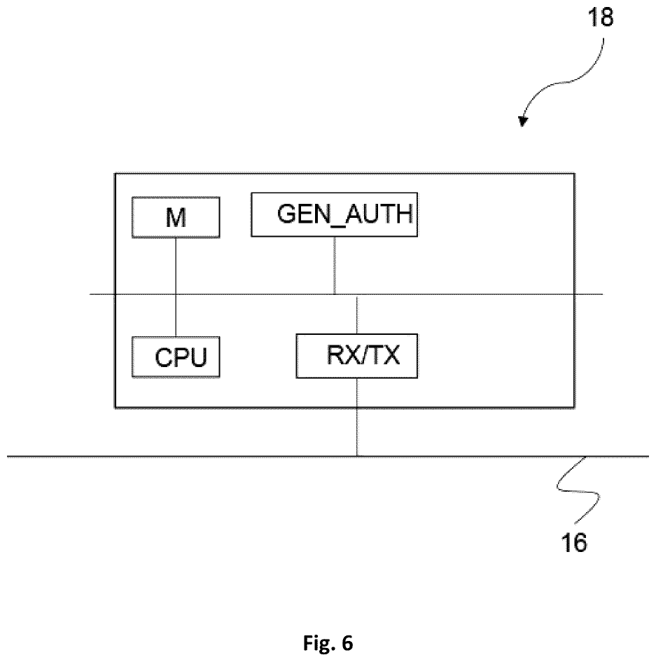

In relation to FIG. 6, the hardware structure of a charging management server 18 of electric vehicles according to one embodiment of the development is now presented. Such a server is, for example, a server hosted by the company of the electric vehicle user, that is dedicated to monitoring the electricity consumption, at the home of employees, caused by the charging of professional electric vehicles, for the purposes of covering the associated costs.

Such a charging management server 18 is configured to store and update an event log, in which it stores in association some items of information relating to the charging of the electric vehicles of the company fleet, that it receives, by means of a wide area communication network of the Internet type to which it is connected, from home charging terminals installed in the home of company's employees. Such an event log makes it possible to monitor the electricity consumption caused by charging the company electric vehicles, and therefore the associated costs, for the purposes of direct payment or reimbursement to the employee user.

In the first embodiment described in relation to FIGS. 2 and 3, such a charging management server 18 is also configured to receive a request for authentication data of an electric vehicle from a home charging terminal, generate an authentication code and transmit it to the mobile terminal of an employee user, whose contact details are stored in a company database accessible to the server, in association with an identifier of the charging terminal that issued the request.

The charging management server 18 typically comprises memories M associated with a processor CPU. The memories can be of type ROM (Read Only Memory), RAM (Random Access Memory) or Flash. Such memories M are used to store the company database in which the identifiers of the home charging terminals installed in the home of employees and the contact details of the latter, for example the telephone number of their professional mobile terminal, are recorded in association. They are also used to store the event log in which, for example, an identifier of the vehicle and data relating to the electricity consumption caused by its charging are stored in association. Such an event log can also comprise information relating to a profile of the electric vehicle, such as its general condition, its mileage or any anomalies observed. In the first embodiment described in relation to FIGS. 2 and 3, such an event log also stores the authentication data request received from the charging terminal, the authentication code generated by the server 18, and associated timestamp data.

Such a charging management server also comprises a transmission/reception module RX/TX that can be connected by means of a wired or wireless link to a wide area communication network 16. In the various embodiments described in relation to the preceding figures, the RX/TX module is the transmission/reception module that manages the reception of all the data from the user's home local communication network, and transmitted by the access gateway 15 via the Internet network 16, and, in the first embodiment, the transmission of the authentication code to the user's mobile terminal 19.

Such a charging management server 18 therefore also includes a GEN_AUTH module for generating an authentication code, that the user must enter on the HMI of the charging terminal 14 to trigger the charging of their electric vehicle 10.

The term “module” can correspond to a software component as well as to a hardware component or a set of hardware and software components, a software component itself corresponding to one or more computer programs or sub-programs, or more generally, to any element of a program capable of implementing a function or set of functions.

FIG. 6 only shows a particular one of several possible ways of realising the charging manager server 18, so that it executes the steps of the method detailed above, in relation to FIGS. 1 to 4 (in any one of the various embodiments, or in a combination of these embodiments). Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the charging manager server 18 is realised with a reprogrammable computing machine, the corresponding program (i.e. the sequence of instructions) may be stored (or not) in a removable storage medium (such as, for example, a floppy disk, CD-ROM or DVD-ROM), this storage medium being partially or totally readable by a computer or a processor.

1. A method for managing the charging of an electric vehicle, via a home charging terminal of the vehicle of a first user,
the method comprising:
connecting a charging cable between the electric vehicle and the home charging terminal;
the home charging terminal receiving authentication data of the electric vehicle; and
the home charging terminal triggering the charging via the home charging terminal after controlling the authentication data when the authentication data relates to a second user, different from the first user and authorised to carry out charging.

2. The method for managing the charging of an electric vehicle according to claim 1, wherein the authentication data of the vehicle is an authentication code associated with the vehicle entered by the first user on an input interface associated with the home charging terminal.

3. The method for managing the charging of an electric vehicle according to claim 2, wherein, during the connection of the charging cable, the home charging terminal sends an authentication data request to a charging management server, capable of generating and transmitting the authentication code to a mobile communication terminal of the first user.

4. The method for managing the charging of an electric vehicle according to claim 3, wherein the home charging terminal is connected to a gateway for access to a local communication network, capable of relaying the authentication data request it receives from the home charging terminal to the charging management server via a wide area communication network.

5. The method for managing the charging of an electric vehicle according to claim 4, wherein the home charging terminal is connected to the access gateway using a communication technology belonging to a group comprising:
a WiFi® technology;
a technology that complies with a G.hn standard as specified by the International Telecommunication Union in recommendations G.9960 et seq.

6. The method for managing the charging of an electric vehicle according to claim 1, wherein the authentication data is transmitted to the home charging terminal by the electric vehicle via the charging cable and comprises a unique identification key of the electric vehicle.

7. The method for managing the charging of an electric vehicle according to claim 6, wherein the authentication data also comprises a profile of the electric vehicle comprising at least some information relating to the electric vehicle belonging to a group comprising:
an identifier of the electric vehicle;
a mileage of the electric vehicle;
an item of information about the state of the electric vehicle;
an identifier of the first user of the electric vehicle;
an anomaly detected on the electric vehicle.

8. The method for managing the charging of an electric vehicle according to claim 6, wherein the home charging terminal implements an authentication of the electric vehicle based on the unique identification key.

9. The method for managing the charging of an electric vehicle according to claim 7, wherein the charging terminal transmits to a charging management server information relating to the electricity consumption associated with the charging of the vehicle, in association with at least some of the information of the profile of the electric vehicle.

10. A processing circuit comprising a processor and a memory, the memory storing program code instructions of a computer program to execute the method for managing the charging of an electric vehicle according to claim 1, when it the computer program is executed by the processor.

11. A home charging terminal of an electric vehicle, configured for implementing the charging management method according to claim 1, comprising a socket for connecting a charging cable of the electric vehicle to the terminal, wherein the home charging terminal comprises:
a module for receiving authentication data of the electric vehicle; and
a module for controlling the authentication data configured to activate the triggering of the charging by the charging terminal.

12. A method for controlling the charging of an electric vehicle implemented by a charging management server, the method comprising:
receiving a vehicle authentication data request from a home charging terminal to which the electric vehicle is connected, the home charging terminal being arranged in a home of a first user and being configured to implement the charging management method according to claim 1;
checking whether the vehicle belongs to a second user different from the first user and whether the first user is authorised to charge the vehicle; and
generating and transmitting an authentication code to a mobile communication terminal of the first user.

13. The method for controlling the charging of an electric vehicle according to claim 12, wherein the charging management server stores an event log in which it records in association the authentication code, an identifier of the charging terminal contained in the authentication data request and an item of timestamp data associated with the request and/or the authentication code.

14. The method for controlling the charging of an electric vehicle according to claim 13 wherein the charging management server sends to an electricity meter present on a local communication network to which the charging terminal is connected, a request to obtain an electricity consumption associated with the charging, the obtaining request containing the item of timestamp data.

15. A processing circuit comprising a processor and a memory, the memory storing program code instructions of a computer program to execute the method for controlling the charging of an electric vehicle according to claim 12, when the computer program is executed by the processor.

16. A charging management server of an electric vehicle, configured for implementing a controlling method according to claim 12, wherein the charging management server comprises a module for receiving an authentication data request from a charging terminal to which the electric vehicle is connected, and a module for generating and transmitting an authentication code to a mobile communication terminal of the first user.
